(19) United States
(12) Patent Application Publication
(10) Pub. No.: US 2022/0084124 A1
(43) Pub. Date: Mar. 17, 2022

(54) SYSTEMS AND METHODS FOR ANONYMOUSLY TRACKING AND COMPARING PORTFOLIOS ACROSS THE SIMILAR INVESTMENT PROFILES

(71) Applicant: JPMORGAN CHASE BANK, N.A., New York, NY (US)

(72) Inventor: Ankur SAMBHAR, Thane West (IN)

(21) Appl. No.: 17/475,048

(22) Filed: Sep. 14, 2021

(30) Foreign Application Priority Data
Sep. 15, 2020 (IN) 202011039919

(51) Int. Cl. G06Q 40/06; G06F 16/27; G06F 16/23; G06F 21/60

(52) U.S. Cl. CPC G06Q 40/06; G06F 16/27; G06N 20/00; G06F 21/602; G06F 16/2379

(57) ABSTRACT

Systems and methods for anonymously tracking and comparing portfolios across the similar investment profiles are disclosed. In one embodiment, an investment portfolio computer program may: (1) receive user investment information from a plurality of users; (1) generate a user investment profile for each of the plurality of users based on the user investment information; encrypt the user investment profiles; (3) write the encrypted user investment profiles to a distributed ledger; (4) compare one of the plurality of user investment profiles to the benchmark portfolio; and (5) generate a recommendation for a user associated with the one of the plurality of user investment profiles based on the comparison.

### RELATED APPLICATIONS

This application claims priority to and the benefit of Indian Patent Application Number 202011039919 filed Sep. 15, 2020, the disclosure of which is hereby incorporated, by reference, in its entirety.

### BACKGROUND OF THE INVENTION

### 1. Field of the Invention

Embodiments relate generally to systems and methods for anonymously tracking and comparing portfolios across the similar investment profiles.

### 2. Description of the Related Art

Presently, each user's portfolio is managed in isolation by the user or by the user's portfolio manager. It may be evaluated and benchmarked against an investment strategy that is specified by the user and/or the portfolio manager. It is also applicable to the wealth managers who manages the complete wealth of high net worth individuals and ultra-high net worth individuals.

The current benchmarking process does not provide the user with the ability to get insights into how other users in the same age group and with similar background are investing. This often leads to overlooking certain aspects while defining the investment strategy.

### SUMMARY OF THE INVENTION

Systems and methods for anonymously tracking and comparing portfolios across the similar investment profiles are disclosed. In one embodiment, a method for distributed ledger based anonymous portfolio tracking may include: (1) receiving, at an investment portfolio computer program, user investment information from a plurality of users; (2) generating, by the investment portfolio computer program, a user investment profile for each of the plurality of users based on the user investment information; (3) encrypting, by the investment portfolio computer program, the user investment profiles; (4) writing, by the investment portfolio computer program, the encrypted user investment profiles to a distributed ledger, wherein a consensus algorithm operating on a plurality of distributed computer nodes updates the distributed ledger in which multiple copies of the distributed ledger exist across the plurality of distributed computer nodes, and the encrypted user investment profile is added to a block in the distributed ledger according to the consensus algorithm; (5) creating, by the investment portfolio computer program, a benchmark portfolio from the plurality of encrypted investment profiles on the distributed ledger; (6) comparing, by the investment portfolio computer program, one of the plurality of user investment profiles to the benchmark portfolio; and (7) generating, by the investment portfolio computer program, a recommendation for a user associated with the one of the plurality of user investment profiles based on the comparison.

In one embodiment, the user investment information may include a type of investment and an amount of investment.

In one embodiment, the method may further include anonymizing, by the investment portfolio computer program, the amount of investment.

In one embodiment, the user investment information may include a user age, a user income, and/or a user investment sophistication level.

In one embodiment, the method may further include genericizing, by the investment portfolio computer program, the user age and/or the user income.

In one embodiment, the benchmark portfolio may be based on the genericized user age and/or the genericized user income.

In one embodiment, the recommendation may be to purchase an investment that is in the benchmark portfolio but not in the one of the plurality of user investment profiles.

In one embodiment, the recommendation may be to sell an investment that is in the one of the plurality of user investment profiles but not in the benchmark portfolio.

In one embodiment, the method may further include generating, for one of the plurality of users, an investment strategy. The recommendation may be further based on the investment strategy.

In one embodiment, the recommendation may be provided by a trained machine learning engine.

According to another embodiment, an electronic device may include a memory storing an investment portfolio computer program and a computer processor. When executed by the computer process, the investment portfolio computer program may cause the computer processor to: receive user investment information from a plurality of users; generate a user investment profile for each of the plurality of users based on the user investment information; encrypt the user investment profiles; write the encrypted user investment profiles to a distributed ledger, wherein a consensus algorithm operating on a plurality of distributed computer nodes updates the distributed ledger in which multiple copies of the distributed ledger exist across the plurality of distributed computer nodes, and the encrypted user investment profile is added to a block in the distributed ledger according to the consensus algorithm; create a benchmark portfolio from the plurality of encrypted investment profiles on the distributed ledger; compare one of the plurality of user investment profiles to the benchmark portfolio; and generate a recommendation for a user associated with the one of the plurality of user investment profiles based on the comparison.

In one embodiment, the user investment information may include a type of investment and an amount of investment.

In one embodiment, the investment portfolio computer program may further cause the computer processor to anonymize the amount of investment.

In one embodiment, the user investment information may include a user age, a user income, and/or a user investment sophistication level.

In one embodiment, the investment portfolio computer program may further cause the computer processor to genericize the user age and/or the user income.

In one embodiment, the benchmark portfolio may be based on the genericized user age and/or the genericized user income.

In one embodiment, the recommendation may be to purchase an investment that is in the benchmark portfolio but not in the one of the plurality of user investment profiles.

In one embodiment, the recommendation may be to sell an investment that is in the one of the plurality of user investment profiles but not in the benchmark portfolio.

In one embodiment, the investment portfolio computer program may further cause the computer processor to: generate, for one of the plurality of users, an investment strategy. The recommendation may be further based on the investment strategy.

In one embodiment, the recommendation may be provided by a trained machine learning engine.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for anonymously tracking and comparing portfolios across the similar investment profiles according to one embodiment.

FIG. 2 depicts a method for anonymously tracking and comparing portfolios across the similar investment profiles according to one embodiment.

### DETAILED DESCRIPTION OF PREFERRED EMBODIMENTS

Embodiments relate generally to systems and methods for anonymously tracking and comparing portfolios across the similar investment profiles.

Embodiments may allow users to be able to benchmark against the similar investment profiles across the geographies anonymously. For example, users may compare and benchmark the user's assets/investments against those of other users across the globe that may have a similar profile. From this, the user may receive insights as to how his or her investment are faring against the those of similarly situated users. Embodiments may allow wealth managers and users, as necessary, to realign their investment strategies based on the comparison.

Embodiments may leverage smart contracts and may write data to a private or public distributed ledger in an encrypted format. Similarly, any changes by the user or a portfolio/wealth manager may also be written to the distributed ledger. The transactions may be encrypted, and smart contracts residing on the same distributed ledger may decrypt the transactions and capture the transaction details. The smart contract may include logic to generate relative benchmarks to similar portfolios.

For example, when an investor's investment manager buys $50 million worth of stock in Company A, the smart contract will update the investor's portfolio. At the same time, it will also recalculate the generic portfolio index based on the investor's investment. It will attempt to capture a pattern, if any, across the transactions for a given user. This may allow the user and/or investment managers to identify how are they doing compared to similarly situated peers. If they identify that most of users in their early thirties are investing heavily in new emerging markets, user and/or investment managers can quickly review the user's portfolio and realign as necessary.

The use of distributed ledgers and smart contracts provides transparency and anonymity. Users are not tracked nor are any of the investments tagged to any specific individuals. Thus, users should be comfortable sharing their investment details via the distributed ledger.

Embodiments may allow users to benchmark their investments against the users with similar investment profiles anonymously, and may assist users in improvising their investment strategies based on the generic investment trend with the similar profile.

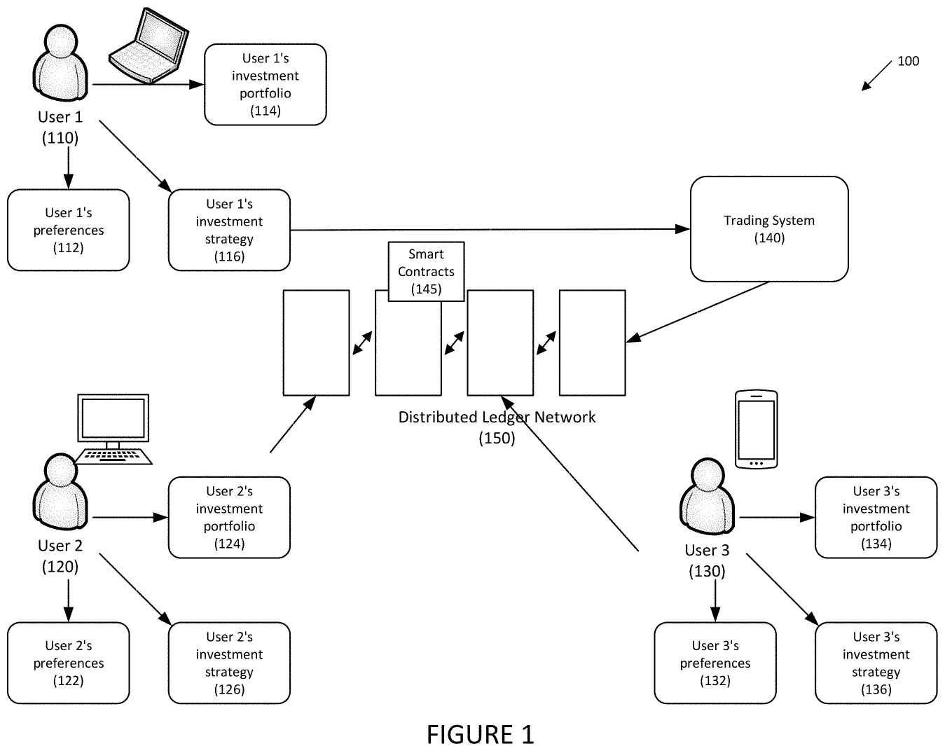

Referring to FIG. 1, an exemplary system for anonymously tracking and comparing portfolio across the similar investment profiles is provided according to one embodiment. System 100 may include a plurality of users (e.g., user 1 110, user 2 120, user 3 130), each user may have preferences (e.g., 112, 122, 132), an investment portfolio (e.g., 114, 124, 134) and investment strategy (e.g., 116, 126, 136). For example, the user preference (e.g., 112, 122, 132) may allow the user to specify his or her own investment profile. The user investment strategy (e.g., 116, 126, 136) may contain the details of the given user's investment strategy based on its investment profile. The user portfolio (e.g., 114, 124, 134) may reflect the current portfolio view of a given user.

In one embodiment, the user preference (e.g., 112, 122, 132) may be specified by the user, or it may be implied based on, for example, age, demographics, current liabilities/assets, future goals, past investment decisions, etc.

Trading system 140 may be any existing trading system that may execute trades.

One or more distributed ledgers may be provided in distributed ledger system 150. An example of a distributed ledger is a blockchain-based distributed ledger, and the distributed ledger may be public, private, or permissioned.

The distributed ledger may be built on distributed ledger/blockchain technology. In embodiments, a consensus algorithm operating on a plurality of distributed computer nodes may update the distributed ledger in which multiple copies of the distributed ledger exist across the plurality of distributed computer nodes. Information may be added to a block in the blockchain-based system according to the consensus algorithm.

In one embodiment, the distributed ledger may allow the verified user transactions to be captured and shared anonymously. When any changes happen to the portfolio of a given user, the changes are captured and written to the distributed ledger. The changes may be encrypted.

The distributed ledger may contain the one or more smart contracts 145 that may capture any changes in portfolios, and generate a view of the relative position among similar investment profiles. The users may be from a similar geographical region, age, income, investment sophistication, etc.

In one embodiment, the system may generate one or more benchmark portfolios that may capture the details about the users' transactions. Each user's portfolio may be compared to one or more benchmark portfolio. The smart contracts 145 may include intelligence to generate the benchmark(s) and perform the comparison. The smart contracts 145 may also decrypt the transaction details posted to the distributed ledger by other users.

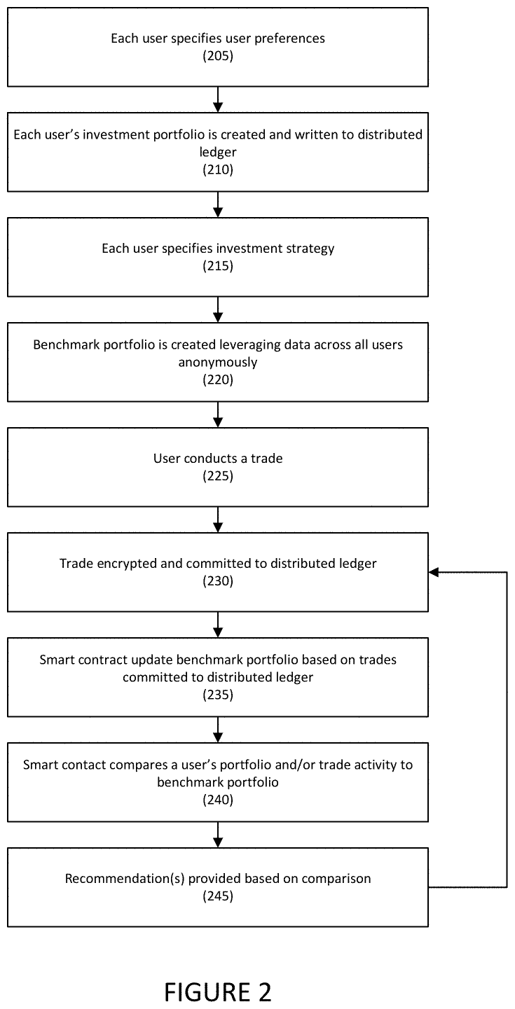

Referring to FIG. 2, a method for anonymously tracking and comparing portfolio across the similar investment profiles is provided according to one embodiment.

In step 205, a plurality of users that are participating in the program may specify their investment preferences. For example, the users may specify a risk profile, preference of market sector, specific region, investment duration (short/medium/long term), types of investment (small/mid/large cap), etc.

In step 210, each user's investment profile may be created. Each investment profile may be manually created, may be retrieved from an investment manager, may be retrieved from investment accounts, etc. In one embodiment, the investment portfolio may include the user's holdings, the type of holdings, the duration, the amount, etc. In embodiments, the investment profiles may be based on the user's past investments.

In embodiments, a trained machine learning engine may infer investment strategies from the user's past investments. Users may have an option to override the inferred strategies in order to align them with the user's current strategies.

In one embodiment, each of the investment portfolios may be encrypted and committed to a distributed ledger. For example, a consensus mechanism operating on the distributed ledger nodes may write the portfolios to the distributed ledger as a block in a blockchain.

In one embodiment, before being encrypted, the investment portfolios may be anonymized. For example, any personally identifiable information (PII) may be removed from the investment portfolio. The investment portfolio may be populated with generic information about the user, such as an age range, a geographical region, an income bracket, an investment sophistication level, etc. In one embodiment, the actual investments in the investment portfolios, such as the name of a holding, amount, etc. may be genericized so that the anonymized investment portfolio cannot be used in reverse to identify the user.

In step 215, each user may specify an investment strategy. In one embodiment, each user may specify a risk level, type(s) of investments, an investment duration, a value of investment, an industry or sector, etc.

In step 220, one or more benchmark portfolios may be created based on the investment portfolios. For example, a smart contract may access the portfolios on the distributed ledger, decrypt them, and generate the benchmark portfolio. In one embodiment, the benchmark portfolios may be created based on a weighted average of user's investment. The weighting may be based on, for example, the portfolio size, the investment amount, the investment history, the user's past investment outcomes, etc. For example, a portfolio for a user with a larger portfolio may receive a greater weighting than that of a user with a smaller portfolio, a portfolio for an experienced investor will receive a greater weighting than that of a novice investor, and a portfolio for a user with a successful investment history may receive a greater weighting than that of a user with a less successful investment history.

In one embodiment, a plurality of benchmark portfolios may be created based on different investor factors, such as age, investment amount, geographic region, investment strategy, income, investment sophistication level, etc.

In step 225, one of the users may conduct a trade, and in step 230, the trade may be encrypted and committed to the distributed ledger. For example, a consensus mechanism operating on the distributed ledger nodes may write the investment to the distributed ledger as a block in a blockchain.

In one embodiment, the transactions may be written to a distributed ledger that is different from the one that the portfolios are written to.

In one embodiment, any user information associated with the trade may be anonymized before it is encrypted and committed. Trade details (e.g., the specific investment, amount, etc.) may also be genericized as is necessary and/or desired.

In step 235, a smart contract, which may be the same as the smart contract that created the benchmark portfolio(s), may update one or more of the benchmark portfolios based on the trade. For example, the smart contract may decrypt the trade, identify the relevant benchmark portfolio(s), and update the relevant portfolio(s).

In one embodiment, if the trade adds a new investment to the benchmark portfolio, the new investment, or a genericized representation thereof, may be added to the benchmark portfolio. Similarly, if the trade removes an existing investment from the benchmark portfolio, the existing investment, or a genericized representation thereof, may be removed from the benchmark portfolio. Similar changes may be made based on modifications to an existing investment.

In step 240, a smart contract, with may be the same or a different smart contract, may compare each user's portfolio to the changed benchmark portfolio(s) and/or the trade activity.

In step 245, one or more recommendation for each user based on the comparison. For example, the recommendation may be to make a similar trade, to make a different trade, to take no action, etc. In one embodiment, the recommendation may be provided by a trained machine learning engine. The machine learning engine may provide a recommendation based on the user profile and preferences. For example, the embodiments may identify an opportunity to invest in Stock ABC, and the trained machine learning engine may use the user profiles and preferences to determine an investment size, an investment duration, etc. for each user.

In one embodiment, the recommendation may be a report of the trade without any recommended action to take.

The process of monitoring trades, updating benchmark portfolios, comparing, and recommending may be repeated.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for distributed ledger based anonymous portfolio tracking, comprising:
receiving, at an investment portfolio computer program, user investment information from a plurality of users;
generating, by the investment portfolio computer program, a user investment profile for each of the plurality of users based on the user investment information;
encrypting, by the investment portfolio computer program, the user investment profiles;
writing, by the investment portfolio computer program, the encrypted user investment profiles to a distributed ledger, wherein a consensus algorithm operating on a plurality of distributed computer nodes updates the distributed ledger in which multiple copies of the distributed ledger exist across the plurality of distributed computer nodes, and the encrypted user investment profile is added to a block in the distributed ledger according to the consensus algorithm;
creating, by the investment portfolio computer program, a benchmark portfolio from the plurality of encrypted investment profiles on the distributed ledger;
comparing, by the investment portfolio computer program, one of the plurality of user investment profiles to the benchmark portfolio; and
generating, by the investment portfolio computer program, a recommendation for a user associated with the one of the plurality of user investment profiles based on the comparison.

2. The method of claim 1, wherein the user investment information comprises a type of investment and an amount of investment.

3. The method of claim 2, wherein the method further comprises:
anonymizing, by the investment portfolio computer program, the amount of investment.

4. The method of claim 1, wherein the user investment information comprises a user age, a user income, and/or a user investment sophistication level.

5. The method of claim 4, wherein the method further comprises:
genericizing, by the investment portfolio computer program, the user age and/or the user income.

6. The method of claim 5, wherein the benchmark portfolio is based on the genericized user age and/or the genericized user income.

7. The method of claim 1, wherein the recommendation is to purchase an investment that is in the benchmark portfolio but not in the one of the plurality of user investment profiles.

8. The method of claim 1, wherein the recommendation is to sell an investment that is in the one of the plurality of user investment profiles but not in the benchmark portfolio.

9. The method of claim 1, further comprising:
generating, for one of the plurality of users, an investment strategy;
wherein the recommendation is further based on the investment strategy.

10. The method of claim 1, wherein the recommendation is provided by a trained machine learning engine.

11. An electronic device, comprising:
a memory storing an investment portfolio computer program; and
a computer processor;
wherein, when executed by the computer process, the investment portfolio computer program causes the computer processor to:
receive user investment information from a plurality of users;
generate a user investment profile for each of the plurality of users based on the user investment information;
encrypt the user investment profiles;
write the encrypted user investment profiles to a distributed ledger, wherein a consensus algorithm operating on a plurality of distributed computer nodes updates the distributed ledger in which multiple copies of the distributed ledger exist across the plurality of distributed computer nodes, and the encrypted user investment profile is added to a block in the distributed ledger according to the consensus algorithm;
create a benchmark portfolio from the plurality of encrypted investment profiles on the distributed ledger;
compare one of the plurality of user investment profiles to the benchmark portfolio; and
generate a recommendation for a user associated with the one of the plurality of user investment profiles based on the comparison.

12. The electronic device of claim 11, wherein the user investment information comprises a type of investment and an amount of investment.

13. The electronic device of claim 12, wherein the investment portfolio computer program further causes the computer processor to anonymize the amount of investment.

14. The electronic device of claim 11, wherein the user investment information comprises a user age, a user income, and/or a user investment sophistication level.

15. The electronic device of claim 14, wherein the investment portfolio computer program further causes the computer processor to genericize the user age and/or the user income.

16. The electronic device of claim 15, wherein the benchmark portfolio is based on the genericized user age and/or the genericized user income.

17. The electronic device of claim 11, wherein the recommendation is to purchase an investment that is in the benchmark portfolio but not in the one of the plurality of user investment profiles.

18. The electronic device of claim 11, wherein the recommendation is to sell an investment that is in the one of the plurality of user investment profiles but not in the benchmark portfolio.

19. The electronic device of claim 11, wherein the investment portfolio computer program further causes the computer processor to:
generate, for one of the plurality of users, an investment strategy;
wherein the recommendation is further based on the investment strategy.

20. The electronic device of claim 11, wherein the recommendation is provided by a trained machine learning engine.
